(19) United States
(12) Patent Application Publication
(10) Pub. No.: US 2008/0020703 A1
(43) Pub. Date: Jan. 24, 2008

(54) BLUETOOTH SATELLITE RADIO REMOTE CONTROLLER

(75) Inventor: Robert Charles Harshaw, Dallas, TX (US)

Correspondence Address: AKIN GUMP STRAUSS HAUER & FELD, LLP, P O BOX 688, DALLAS, TX, 75313-0688, US

(73) Assignee: Heads Up Technologies, Dallas, TX (US)

(21) Appl. No.: 11/458,882

(22) Filed: Jul. 20, 2006

(51) Int. Cl. H04H 1/00

(52) U.S. Cl. 455/3.02

(57) ABSTRACT

XM satellite Bluetooth communication receivers, Bluetooth wireless remote controller communication device, Bluetooth communication methods, and wireless communication methods are provided. The present invention provides Bluetooth communication receivers for radio programming and radio/weather programming including communication circuitry configured to communicate wireless signals using a plurality of communication links according to a Bluetooth communication protocol with a wireless remote controller that integrates Bluetooth and OLED technologies to provide real-time satellite programming information, or the like.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

The present invention relates to communication systems, units and devices connected using wireless links, such as systems and devices that use the Bluetooth technology. Specifically, the present invention pertains to wireless communications used to bi-directionally transmit satellite radio user interface information with a remote control device. More specifically, the present invention pertains to an aircraft satellite receiver system remote device for controlling a satellite radio receiver and displaying associated audio programming information to a user utilizing Bluetooth wireless communications.

XM Satellite Radio is one of the most popular satellite radio services offered in today's market. XM provides its subscribing customers with satellite radio service providing over 150 channels of a variety of music, sports, talk, comedy, drama, news, traffic, weather, kids programming and more. All music channels are provided commercial free and XM's weather channels provide the most comprehensive, in-depth information on radio.

In today's progressive and ever changing high tech consumer society, convenience and function are at the forefront of customer expectations. Specifically, with the introduction of XM radio, the availability of receivers and functional remote control devices that provide specific satellite programming information directly on the remote in real-time are absent, especially when affiliated with use and availability in modern aircraft. In addition, absent are such devices that use minimal power while simultaneously providing superior illumination and graphics clarity.

As such, remote control devices in each of their present forms have a number of associated shortcomings. For example, a remote control device typically serves to provide basic control functions for its associated equipment, but without the benefit of visual representation of the associated equipment's programming being changed.

Another shortcoming associated with current remote control devices, specifically those used in conjunction with satellite radio receivers, is their line of sight transmission limitations. Commonly, remote control devices use infrared beams to communicate commands to the device that is to be controlled, and so the remote control devices can only be used for line-of-sight applications. Devices behind an object, around a corner, or in another area nearby cannot be controlled if they are not in the line of sight of an infrared remote.

A more modern solution is to wire devices together into a network of some sort, so that they can be controlled from a central location. However, this approach also has a number of shortcomings. For example, the connections and cabling needed may be quite cumbersome and complex. In addition, this approach is difficult and expensive to backfit into existing aircraft or other areas. Furthermore, such an approach is not necessarily convenient or practical for many reasons in today's aircraft.

Accordingly, a need exists for a system and/or device that can be used to remotely control a satellite radio receiver while simultaneously displaying real-time programming information to the user on the remote using minimal power while simultaneously providing superior illumination and graphics clarity.

A need also exists for a system and/or device that can satisfy the above need, that is relatively simple and cost effective to introduce into aircraft and that is user-friendly.

In addition, a need exists for a system and/or device that satisfies the above needs, is portable, and is not limited to line-of-sight applications.

### SUMMARY OF THE INVENTION

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is therefore an object of the present invention to provide a system and device for controlling satellite programming and displaying programming information, or the like, directly on the remote in real-time using minimal power and providing superior illumination and graphics clarity.

It is a further object of the present invention to provide a wireless system and device for transmitting satellite radio/weather user interface data/graphics information to and from a remote control device.

It is a further object of the present invention to provide a relatively simple and cost effective and user-friendly wireless system and device for aircraft for controlling satellite programming and displaying satellite programming information directly on the remote in real-time.

It is yet a further object of the present invention to provide a system and portable remote device that is not limited to line-of-sight applications for controlling satellite programming and displaying the information in real-time directly on the remote device.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

FIG. 1 depicts an overview of an XM satellite radio and/or weather receiver and a Bluetooth satellite radio wireless controller remote device according to the present invention;

FIG. 2 depicts an internal schematic diagram of an XM satellite radio and/or weather receiver according to the present invention;

FIG. 3 depicts an internal diagram of the Bluetooth satellite radio wireless controller remote device according to the present invention;

FIG. 4 depicts and exploded view of the Bluetooth satellite radio wireless controller remote device according to the present invention;

FIG. 5 depicts a front view of the Bluetooth satellite radio wireless controller remote device according to the present invention;

FIG. 6 depicts a perspective view of the back of the Bluetooth satellite radio wireless controller remote device according to the present invention;

FIG. 7 depicts a front view of the display screen the Bluetooth satellite radio wireless controller remote device according to the present invention; and

FIGS. 8A-8D together depict a top, perspective, back and a side view, respectively, of the XM satellite radio/radio-weather receiver according to the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

As an introduction to the present invention, the context of the following discussion is primarily one in which a remote control device and receiver system(s) are integrated, utilized and coupled into aircraft cockpits and/or cabins using wireless technology, and specifically with regard to such devices and systems compliant with Bluetooth technology. Bluetooth is the code name for a technology specification for small form factor, low-cost, short-range radio links between devices. The Bluetooth technology allows cables that connect one device to another to be replaced with short-range radio links. Bluetooth has been typically targeted at mobile and business users who need to establish a wireless link or small network between their computer, cellular phone and other peripherals. The required and nominal range of Bluetooth is thus set to approximately ten (10) meters. To support other uses, Bluetooth can be augmented to extend the range to up to 100 meters.

The Bluetooth technology is based on a high-performance, yet low-cost, integrated radio transceiver. Bluetooth radio technology can also provide: a universal bridge to existing data networks, a peripheral interface, and a mechanism to form small private ad hoc groupings of connected devices away from fixed network infrastructures.

On disclosed embodiment of the present invention provides for the next generation of satellite radio receivers and Bluetooth remote controllers each designed to provide all the enjoyment of audio programming utilizing a single receiver, but without the requirement to integrate the receiver into existing aircraft cabin entertainment management systems. However, one skilled in the art will understand that the present invention contemplates that the invention can be adapted for uses outside of the aircraft cabin and cockpit environment without departing from the scope and spirit of the present invention including, but not limited to, uses in automobile vehicles, single and multifamily residences and commercial establishments. It is further understood the other communication schemes and protocols may be implemented without detracting from the scope and spirit of the present invention.

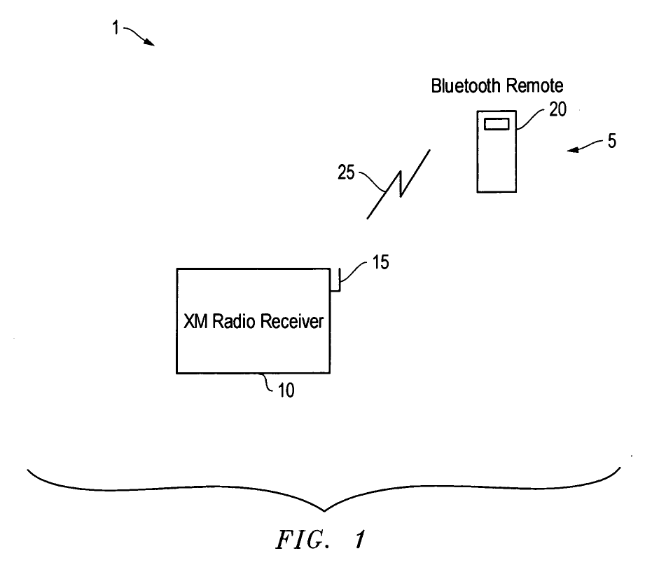

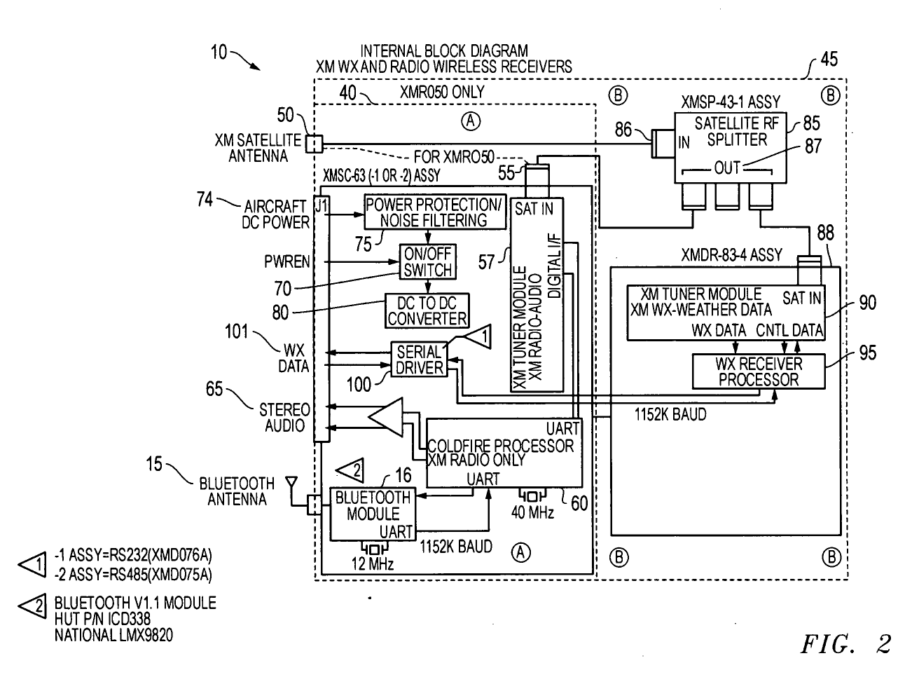

Referring now to the drawings and initially to FIG. 1, the system 1 of one disclosed embodiment of the present invention comprises an XM satellite radio receiver 10 and a Bluetooth remote controller 5. The receiver 10 permits at least Bluetooth RF omni-directional transmission and receipt of communications and instructions between the receiver 10 and the remote controller 5 through low-density walls and other obstructions via a wireless signal link 25 using an integrated Bluetooth antenna 15 that is removably disposed on a portion of the XM satellite radio receiver 10 (described in detail below with reference to FIG. 2).

The remote controller 5 of one disclosed embodiment comprises a display screen 20 that utilizes organic light emitting diodes (OLEDS) to provide superior illumination and clarity to a variety of graphics displayed on the display screen 20. However, although the disclosure herein primarily discloses use of OLEDs for illumination, the present invention contemplates use of alternative displays such as, but not limited to, the many various types and models of liquid crystal displays (LCD) and further contemplates future means of displaying graphics data on a screen. Such display screen 20 graphics depict a plurality of satellite program programming data including, but not limited to, information specific to the station, music, other programming and/or various device status indicators. These programming data and indicators are discussed in further detail below with reference to FIG. 7.

With reference now to FIG. 2 what is depicted is an internal schematic diagram of the XM satellite radio and/or weather receiver(s) 10 of the present invention. FIG. 2 specifically depicts two embodiments of the receiver 10 of the present invention. One embodiment provides functionality only as an XM radio (i.e., audio only) receiver device 40 and is indicated in FIG. 2 by segment “A” (hereafter referred to as 40 “A”) and a second embodiment functions as an XM weather data receiver device comprising an integrated XM radio portion 45 is indicated in the FIG. 2 by segment “B” (hereafter referred to as 45 “B”). Both embodiments providing over 150 channels of commercial free satellite programming capability (e.g., XM or other satellite programming music, sports, talk, comedy, drama, news, traffic and weather reports, kids programming and more) and at least 17 program groups, wherein each station has a nominal access time of about 1-3 seconds.

Specifically, in reference to the first embodiment, the XM radio receiver device 40 “A”, receives satellite signal data via at least one XM satellite antenna connected at an antenna in port 50. The antenna in port 50 is directly connected, in this embodiment, by way of connection 55 to an XM radio-audio only tuner module 57 that provides information flow connectivity to a microprocessor 60 (for example, but not limited to a Coldfire microprocessor) that is then connected to stereo audio outputs 65. The microprocessor 60 functions to store and execute software code instructions to operate an XM operating system and to facilitate remote communications with the remote controller 5 device.

In addition, the XM radio receiver device 40 “A” comprises a Bluetooth module 16 that is further communicably connected with a Bluetooth antenna 15. In one embodiment the present invention utilizes a National Semiconductor® LMX9820 Bluetooth™ Serial Port module that is a highly integrated radio, baseband controller and memory device implemented on an LTCC (Low Temperature Co-fired Ceramic) substrate.

The Bluetooth module 16, the microprocessor 60 and the XM radio-audio only tuner module 57 utilize a Universal Asynchronous Receiver/Transmitter (UART) controller and is a key component of the serial communications subsystem of the system. The UART takes bytes of data and transmits the individual bits in a sequential fashion. At the destination (e.g., in the remote controller 5), a second Bluetooth module 17 (i.e., also a National Semiconductor® LMX9820 Bluetooth™ Serial Port module) re-assembles the bits into complete bytes.

As stated, the second embodiment functions as an XM weather data receiver device comprising an integrated XM radio portion 45 “B”. It should be understood that the XM radio (i.e., audio only) receiver device 40 “A” does not contain specific components and operational capabilities of the XM weather data receiver device 45 “B”. In both receiver 10 embodiments (40 “A” and 45 “B”), the remote controller 5 is utilized for the XM radio audio portion of each receiver (i.e., the remote controller 5 specifically does not function to operate, control and/or display information pertaining to the XM weather data receiver device 45 “B”). However, the present invention contemplates other embodiments that accommodate display of a variety of a plurality of other received and/or selected satellite information relating to various weather and other informational categories of information. Specifically, the invention disclosed herein is not meant to be limiting in the category and type of information capable of being transceived by the receiver(s) 10 and transceived, processed and displayed by the remote controller 5.

According to the present invention, the combination XM weather data receiver with integrated XM radio 45 “B” utilizes RS232 and/or RS422 databus protocol interfaces to forward XM weather serial data to the remote controller 5 display screen 20. Similar to receiver embodiment 40 “A”, the present XM weather data receiver device 45 “B” also utilizes a Bluetooth module 16 connected to the Bluetooth antenna 15.

In the XM weather data receiver device 45 “B”, the device receives satellite signal data via at least one XM satellite antenna connected at an antenna in port 50. The antenna in port 50 is directly connected, in this embodiment, by way of connection in port 86 to a novel satellite RF splitter 85 comprising three out port connections 87. As shown in FIG. 2 one out port connection 87 is connected by way of connection 55 to the XM tuner module 57 (described above) that provides information flow connectivity to the microprocessor 60 (as described above) that is then connected to stereo audio outputs 65 and also to a Bluetooth module 16 that is further communicably connected with a Bluetooth antenna 15.

As also shown in FIG. 2 another one of the three out port connections 87 is connected by way of satellite in connection 88 to an XM tuner weather data module 90. The XM tuner weather data module 90 is then connected to a serial device driver 100 for a serial weather data port 101 for communicating weather and control data via a weather receiver microprocessor 95 to the XM tuner weather data module 90.

It should be understood that both receiver embodiments, 40 “A” and 45 “B”, are connected to aircraft DC power via an ON/OFF switch 70 that connects (i.e., when switched ON) power to the receiver, 40 “A” or 45 “B”, via an aircraft DC power port 74. Importantly, a DC-to-DC converter 80 is provided and accepts a DC input voltage and produces a DC output voltage. Typically, the output produced is at a different voltage level than the input. Both embodiments also provide power bus protection and noise isolation and filtering components 75.

Now turning to FIG. 3, an internal schematic diagram of the Bluetooth remote controller 5 is shown. As mentioned, the remote controller 5 of one disclosed embodiment of the present invention utilizes and integrates, but is not limited solely to, the technologies of Bluetooth wireless communications and organic light emitting diodes (OLEDs) to provide an extremely flexible and cost effective approach for providing XM information on a remote controller 5 display screen 20. Importantly, such use of Bluetooth technology reduces the expense of installation and avoids “line-of-sight” issues with traditional IR remotes.

In FIG. 3, the remote controller 5 is schematically depicted as having a Bluetooth module 17 that is further communicably connected with a 2.4 Ghz Bluetooth antenna 18. In the remote controller 5 the module utilized is a National Semiconductor® LMX9820 Bluetooth™ Serial Port module that is a highly integrated radio, baseband controller and memory device implemented on an LTCC (Low Temperature Co-fired Ceramic) substrate substantially similar to that used in the receiver 10.

The remote controller 5 also utilize a microprocessor 61 (for example, but not limited to, a Coldfire microprocessor) that is operationally connected to the display screen 20 and an elastomer keypad 25 used for data entry and selection. Similar to the embodiment described above, the remote controller microprocessor 61 stores and executes computer code for facilitating communications with the receiver 10 embodiments, 40 “A” and 45 “B”.

Also provided and shown in FIG. 3 is a DC to DC converter and power controller 81 that is electrically connected to three AAA battery of provision of power to the remote controller 5. The remote controller 5 allows a user to select, operate and/or display receiver 10 embodiment 40 “A” (i.e., audio only) selections of various satellite audio programming directly on the remote controller 5 display screen 20 (discussed in detail with reference to FIG. 7) further providing near instantaneous feedback from the receiver 10 for display on the remote controller 5 display screen 20. The present invention contemplates the use of such novel functionality in other aspects of technology devices and is not limited to future growth and development for utilization outside of only satellite programming display and functionality.

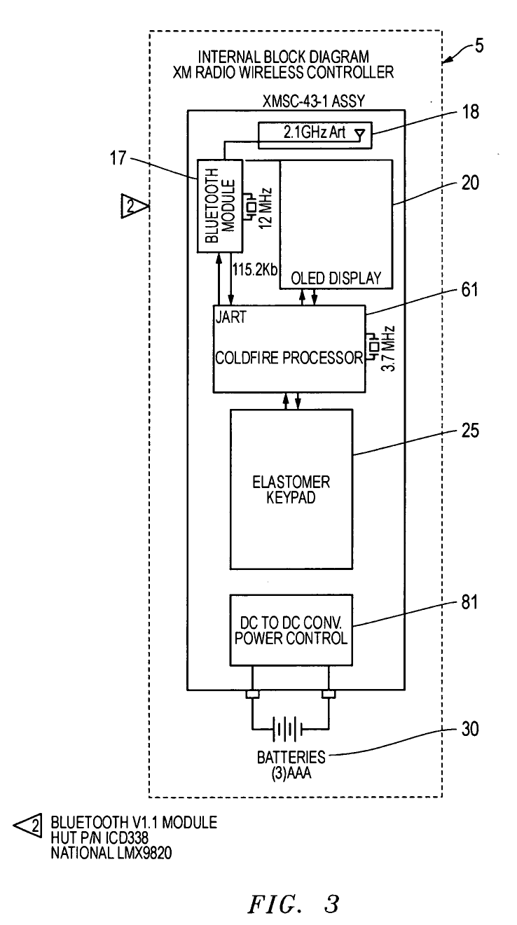

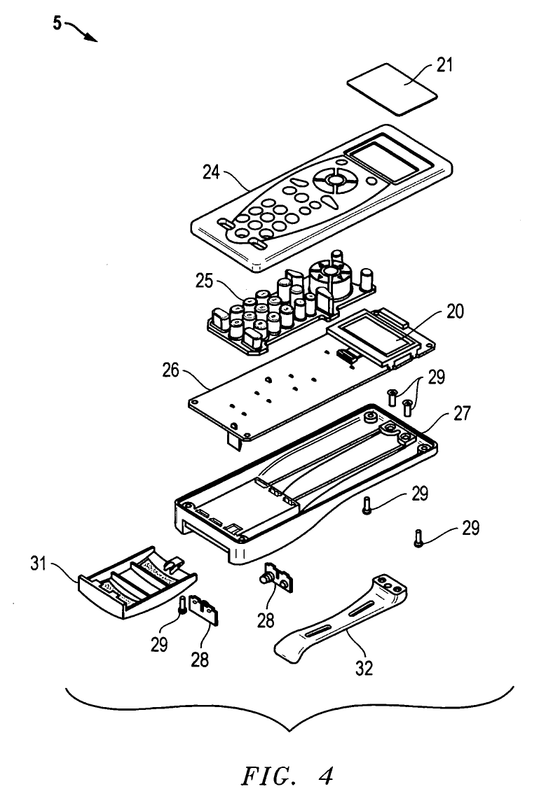

With reference now to FIG. 4, what is shown is an exploded view of the Bluetooth satellite radio wireless remote controller 5 according to the present invention. The remote controller 5 is manufactured and constructed utilizing a high strength, painted polymer having two attachment points (e.g., one for a lanyard, and one for a clip 7 used to attach to fabric, vinyl or leather pouches, pockets and belts). The remote controller 5 is manufactured having a plurality of separate components such as a painted remote case top 24, a remote case keypad/input devices 25, an OLED, LCD or other type display screen 20 w/protective cover 21, a remote printed wiring assembly (PWA) 26 comprising the components and connections described in relation with FIG. 3 above, a painted remote case bottom 27, a battery compartment cover 31, a plurality of “AAA” battery contacts 28, a remote case clip assembly 32 (described above) and a plurality of fasteners 29 (e.g., screws). Although not meant to be limiting, the present disclosed embodiment's specific use of a graphics layout (shown in FIG. 7) for the display screen 20 and the remote case keypad/input devices 25 layout utilize a predetermined format and layout licensed from XM Satellite Radio, Inc.

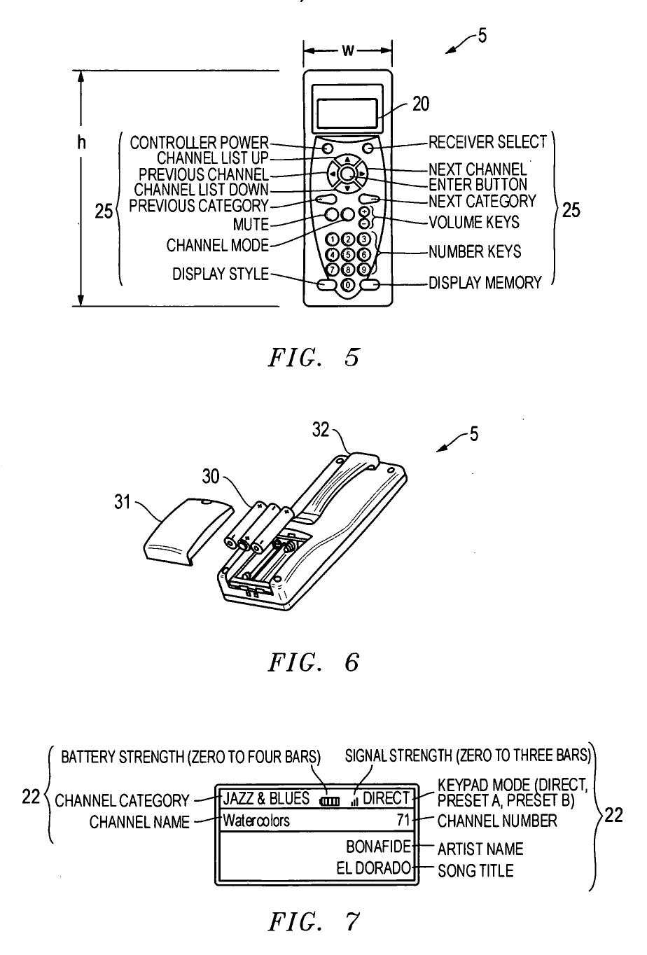

With reference now to FIG. 5, a front view of the remote controller 5 according to the present invention is shown. The remote controller 5 has dimensions as follows: 6.25″ H, 2.25″ W and 1.46″ D (not shown) and weighs about 0.39 lbs. The display screen 20 has a 180 degree viewing angle with 128×64 resolution capability. As previously mentioned, the remote controller 5 offer multi-functionality for controlling, selecting and displaying satellite programming information. The remote case keypad 25 (discussed above in reference to FIG. 4) provides various user controlled function selections. Specifically, the remote case keypad 25 provides for controller power to turn the receiver 10 (40 “A” and/or 45 “B”) power on or off, receiver select functionality to search for and set receiver 10 ID, channel list up and down buttons used to move up or down through channel lists, previous and next channel, channel list enter used to selected a highlighted channel, previous and next category for providing category search and display of channels grouped by category, audio mute to mute and unmute audio output, channel mode key to provide selection between “direct” (direct channel entry) and preset “A” and “B” options, volume up and down, number keys (0-9) used to select a channel directly when in direct entry mode and to select or set presets when in a preset mode, display format select used to toggle between two display options (#1—channel name, channel number, artist name, and song title; #2—channel name, and a big channel number), and memory used to save artist name and song title information.

With reference now to FIG. 6, the remote controller 5 is shown from a perspective view of the back to provide visual cues of the installation of the attachment clip 32 to the painted remote case bottom 27. In addition, the “AAA” battery 30 installation and accompanying battery compartment cover are shown.

FIG. 7 depicts a front view of the display screen 20 the Bluetooth satellite radio wireless remote controller 5 according to the present invention. The display screen 20 shown in FIG. 7 provides an example of the type of programming information (i.e., satellite radio programming) that the present invention displays directly on the front of the remote controller 5. This information is directly communicated from the satellite to the receiver 10 and then to the remote controller 5 for visual consumption and functional selections by the user. Data changes at the receiver are communicated to the remote controller 5 for additional display.

More specifically, the information provided on the remote controller's 5 display screen 20 is of a predetermined format such as, but not limited to, the familiar XM format and comprises status and programming information 22 such as battery strength (zero to four bars), channel categories (such as, but not limited to jazz and blues, country, rock, hits, classical music and radio Disney), channel name, signal reception strength (e.g., zero to three bars), keypad mode (e.g., direct, preset A, preset B), channel number, artist name and song titles. It will be understood and is contemplated that alternate functionality and information can transmitted and displayed on the display screen 20 and is not limited solely to satellite radio programming only.

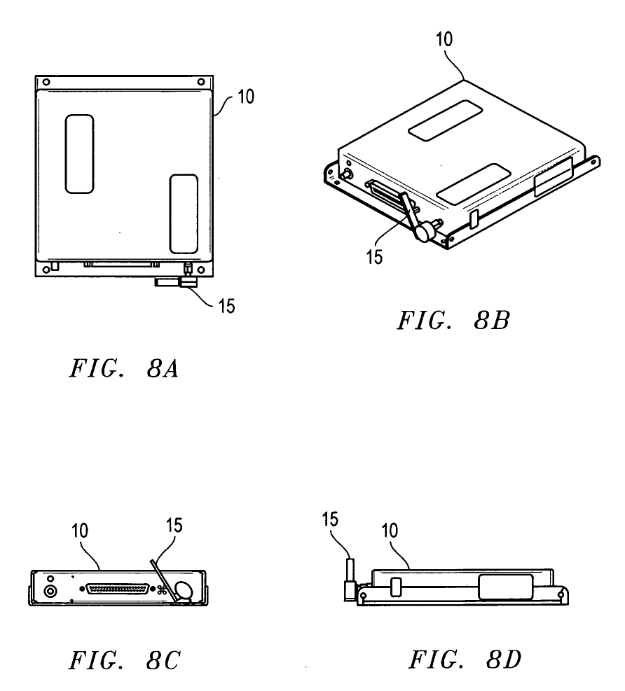

In FIGS. 8A through 8D the receiver 10 is depicted in a plurality of views wherein each view the Bluetooth antenna 15 is shown as disposed on the chassis of the receiver. In embodiment 40 “A”, the receiver 10 has dimensions of: 1.35″ H, 6.46″ W and 7.80″ D and a weight of 1.17 lbs. In embodiment 45 “B”, the receiver 10 has dimensions of: 1.82″ H, 6.46″ W and 7.80″ D and a weight of 1.70 lbs.

The above disclosure provides for an XM receiver 10 having satellite programming information that is remotely controlled by the present invention's remote controller 5. Such real-time functionality and programming display directly on a remote control device is not available in today's market. The present invention meets that need and contemplates future technological advancements that allow other improvements and functionality by way of the Bluetooth or similar future advanced technologies. In addition, although the present invention is described in connection and use in aircraft, the inventors of the present invention contemplate that such applications are unlimited and are covered by the present disclosure.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

It is therefore, contemplated that the claims will cover any such modifications or embodiments that fall within the true scope of the invention.

What is claimed is:

1. A wireless satellite radio programming system comprising:
a wireless satellite receiver having a microprocessor in communication with a Bluetooth module;
a wireless communication software interface associated with the receiver;
a wireless remote controller having a plurality of input devices;
a display screen disposed with the remote controller for displaying a plurality of real-time satellite radio programming information and status indicators as received from the receiver; and,
wherein communication between the microprocessor and the remote controller is via the wireless communication interface to transceive information from input signals received from the remote controller for selecting programming.

2. The wireless satellite radio programming system as in claim 1, wherein the receiver can be an XM radio-audio only receiver or a combination XM radio and weather receiver.

3. The wireless satellite radio programming system as in claim 2, wherein the combination XM radio and weather receiver device further comprises a satellite RF splitter having at least one input and at least three outputs, wherein the outputs are connected to at least the input port of an XM tuner radio module and the input of a separate XM weather data module.

4. The wireless satellite radio programming system as in claim 3, wherein RS232 and/or RS422 databus protocol interfaces are utilized to forward XM weather data to the display screen.

5. The wireless satellite radio programming system as in claim 1, wherein the plurality of input devices allow user selection of a plurality of programming comprising controller power, channel list up and down, previous and next channel, channel list enter, previous and next category, audio mute, channel mode key, volume up and down, number keys (0-9), display format select and memory.

6. The wireless satellite radio programming system as in claim 1, wherein the display screen utilizes organic light emitting diodes for providing illumination of the screen.

7. The wireless satellite radio programming system as in claim 1, wherein the display screen is of the liquid crystal display type.

8. The wireless satellite radio programming system as in claim 1, wherein the display screen displays information specific to a channel category, channel name, battery strength, signal strength, keypad mode, channel number, artist name and song title and other programming and/or various device status indicators.

9. A wireless satellite radio remote controller comprising:
a Bluetooth module;
a microprocessor in communication with the Bluetooth module, wherein the microprocessor is programmed with an operating system software for facilitating sending and receiving of communication signals between the controller and a satellite receiver; and
a display screen in communication with the microprocessor; and,
a plurality of input devices, in communication with the microprocessor, for providing user selection of at least satellite programming information.

10. The wireless satellite radio remote controller as in claim 7, wherein the display screen utilizes organic light emitting diodes for providing illumination of the screen.

11. The wireless satellite radio remote controller as in claim 7, wherein the display screen is of the liquid crystal display type.

12. The wireless satellite radio remote controller as in claim 7, wherein the display screen displays information in a predetermined format and layout, such as but not limited to the XM format, that is specific to a channel category, channel name, battery strength, signal strength, keypad mode, channel number, artist name and song title and other programming and/or various device status indicators.

13. The wireless satellite radio remote controller as in claim 7, wherein the plurality of input devices are in a predetermined format and layout, such as but not limited to the XM format, allow user selection of a plurality of programming comprising controller power, channel list up and down, previous and next channel, channel list enter, previous and next category, audio mute, channel mode key, volume up and down, number keys (0-9), display format select and memory.

14. The wireless satellite radio remote controller as in claim 7, wherein a plurality of attachment points or devices are provided.

15. The wireless satellite radio remote controller as in claim 10, wherein at least one attachment point permits attachment of a lanyard.

16. The wireless satellite radio remote controller as in claim 10, wherein at least one attachment device is a removable clip.

17. The wireless satellite radio remote controller as in claim 7, wherein the Bluetooth module is communicably connected with a 2.4 Ghz Bluetooth antenna.

18. The wireless satellite radio remote controller as in claim 7, the Bluetooth module is a National Semiconductor® LMX9820 Bluetooth™ Serial Port module.

19. The wireless satellite radio remote controller as in claim 7, wherein data forwarded from the receiver via RS232 or RS485 databus protocol interfaces is utilized to communicate data for display on the display screen.

20. A method for providing remote control selection and display of satellite radio programming, the method comprising the steps of:
providing a satellite receiver;
providing a communications interface associated with the satellite receiver;
providing a microprocessor in communication with the receiver, the microprocessor programmed with a software having a satellite radio operating system programmed thereon;
providing a remote controller, wherein the remote controller comprises an operating system for facilitating communication with the receiver; and,
providing a display screen disposed on the remote controller, wherein the display screen provides real-time user selected satellite programming information and status information.

21. The method for providing remote control selection and display of satellite radio programming as in claim 20, wherein the display screen utilizes organic light emitting diodes for providing illumination of the screen.

22. The method for providing remote control selection and display of satellite radio programming as in claim 20, wherein the display screen is of the liquid crystal display type.

23. The method for providing remote control selection and display of satellite radio programming as in claim 20, wherein the satellite receiver comprises a Bluetooth module for wireless communication.

24. The method for providing remote control selection and display of satellite radio programming as in claim 20, wherein the remote controller comprises a Bluetooth module for wireless communication.

25. The method for providing remote control selection and display of satellite radio programming as in claim 20, wherein data changes at the receiver are communicated to the remote controller for display thereon.

26. The method for providing remote control selection and display of satellite radio programming as in claim 20, wherein the receiver can be an XM radio-audio only receiver or a combination XM radio and weather receiver.

27. The method for providing remote control selection and display of satellite radio programming as in claim 26, wherein the combination XM radio and weather receiver device further comprises a satellite RF splitter having at least one input and at least three outputs, wherein the outputs are connected to at least the input port of an XM tuner radio module and the input of a separate XM weather data module.

28. The method for providing remote control selection and display of satellite radio programming as in claim 27, wherein RS232 and/or RS422 databus protocol interfaces are utilized to forward XM weather data to the display screen.

29. The method for providing remote control selection and display of satellite radio programming as in claim 26, wherein the plurality of input devices allow user selection of a plurality of programming comprising controller power, channel list up and down, previous and next channel, channel list enter, previous and next category, audio mute, channel mode key, volume up and down, number keys (0-9), display format select and memory.

30. The wireless satellite radio programming system as in claim 26, wherein the display screen displays information specific to a channel category, channel name, battery strength, signal strength, keypad mode, channel number, artist name and song title and other programming and/or various device status indicators.
